(19) United States
(12) Patent Application Publication
(10) Pub. No.: US 2011/0135134 A1
(43) Pub. Date: Jun. 9, 2011

(54) HEADSET WITH SIDE SUPPORT

(75) Inventors: Mohamad ESSABAR, Solrod Strand (DK); Peter Vestergaard VAERUM, Solrod Strand (DK); Dennis W. HANSEN, Solrod Strand (DK); Peder Hesselbjerg PEDERSEN, Solrod Strand (DK); Lars Elliot NYEGAARD, Solrod Strand (DK); Christian WANG, Solrod Strand (DK)

(73) Assignee: SENNHEISER COMMUNICATIONS A/S, Solrod Strand (DK)

(21) Appl. No.: 12/940,417

(22) Filed: Nov. 5, 2010

Related U.S. Application Data
(60) Provisional application No. 61/266,524, filed on Dec. 4, 2009.

(30) Foreign Application Priority Data
Dec. 4, 2009 (EP) 09177988.4

(51) Int. Cl. H04R 1/10

(52) U.S. Cl. 381/374

(57) ABSTRACT

A headset with side support is provided, where a speaker module is coupled to a side support by means of an elongate resilient spring such that the speaker module and the side support are placeable at each their side of a users head and where the spring provides a holding force which presses the speaker module and the side support in a direction towards each other wherein the spring comprises a metal core and this core comprises a re-enforcement at the side support which extends transversely to the length direction of the elongate spring.

### AREA OF THE INVENTION

The invention regards a headset which has a side support at one side and a speaker and microphone module at an opposite side. A resilient spring part interconnects the two parts such that the two elements may be pulled apart and the headset placed at the head of a user with the speaker module at one ear and the side support above or behind the other ear, whereby the spring will exert a force pressing the speaker and side support in a direction against each other. This pressure secures the headset on the users head in the correct position.

### BACKGROUND OF THE INVENTION

In a headset of the above kind it is known to arrange the battery at the side support in order to achieve a better weight balance between speaker part and support part. An example of this is shown in f JP 2002057766 (A). In such systems there is a risk that the side support may come away from the resilient spring, as a result of rough handling by the user. This may happen if the user pulls at the side support in order to adjust the length of the spring element which will usually be telescopically connected to the speaker element.

### SUMMARY OF THE INVENTION

According to the invention, a headset with side support is provided, where a speaker module is coupled to a side support by means of an elongate resilient spring such that the speaker module and the side support are placeable at each their side of a users head and where the spring provides a holding force which presses the speaker module and the side support in a direction towards each other.

In order to solve the above mentioned problem the spring comprises a metal core and this core comprises a re-enforcement at the side support which extends transversely to the length direction of the elongate spring.

By having a spring with a metal core which comprises a transversely extending re-enforcement, it is ensured that the side support will not come away from the spring, even if the side support is pulled at hard by the user. A dispersion of the pressure force from the spring is also facilitated by the transversely extending re-enforcement.

In a preferred embodiment of the invention the re-enforcement is made from metal and is at least partially embedded in a polymer material. A metal re-enforcement is readily connected to the metal spring core through a well known process such as welding or soldering. By embedding the re-enforcement in a polymer material, the possible junction between metal spring core and re-enforcement may be kept invisible, and also sharp edges of the metal parts may be covered. If a relatively soft polymer material is chosen, a very comfortable side support may be obtained, which due to the presence of the re-enforcement will still have a considerable strength.

In an embodiment of the invention a battery is accommodated at the side support and connection leads between the battery and the speaker module are provided along the resilient spring. By providing the battery at the side support, a better balance between the speaker part and the side support is achieved, and at the same time the speaker part may be made somewhat smaller. Further, the battery must be well protected, and to this end the re-enforcement part plays a role, and ensures that the battery is well protected.

In a further embodiment the re-enforcement comprise a plate element having raised rim parts, whereby the battery is accommodated between the raised rim parts. The plate part facilitates accommodation of the battery, especially if a flat battery pack is used, and the rim part plays a role in strengthening the element, especially against bending forces which the user may in-advertently expose the side support to in daily use of the headset.

It is preferred that the polymer material and the re-enforcement plate in unison with a battery lid defines a battery enclosure. The battery lid may be removed, such that the battery may be replaced in the event that the battery is worn down. Preferably a re-chargeable battery is used, and the battery lid is not supposed to come off in daily use of the headset, but also a rechargeable battery may fail or wear out and thus it should be possible to replace the battery.

Preferably the battery lid attaches directly to flanged parts of the re-enforcement at each side of the battery enclosure. In this way it is ensured, that even if a relatively soft polymer material has been used for the embedding of the re-enforcement part, the battery lid may be secure and safely attached to the side support. Further, as the re-enforcement part is a metal part a very strong force may be provided between the rim of the battery enclosure and the battery lid, such that a moisture tight seal may be provided.

It is preferred that the lead comprise a coiled part, as this allows the spring to be telescoped in and out of the speaker part, whereby the side support may be adjusted to abut the users head in a preferred position.

Preferably the coiled or spiralled part is arranged at the speaker module inside a sheath connected to the speaker module. In this way the coiled part of the lead is well protected.

In an embodiment of the invention, the resilient spring is slidably arranged in the sheath part, and the coiled part of the lead is arranged to allow movement between the sheath and the resilient spring. The coiled or spiralled lead may be arranged with a coil axis, either perpendicular or in line with the movement direction of the resilient spring. It is preferred to arrange the coil with a coil axis in line with the movement direction of the spring, and the spiral or coil will then allow the movement through pitch change of the windings and a diameter change when the lead is pulled at.

As used herein, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements maybe present, unless expressly stated otherwise. Furthermore, “connected” or “coupled” as used herein may include wirelessly connected or coupled. As used herein, the term “and/or” includes any and all combinations of one or more of the associated listed items. The steps of any method disclosed herein do not have to be performed in the exact order disclosed, unless expressly stated otherwise.

### BRIEF DESCRIPTION OF THE DRAWINGS

FIG. 1 shows an embodiment of the headset according to the invention in a 3D to projectional view,

FIG. 2 shows the 3D projectional view of FIG. 1, but with external elements being removed,

FIG. 3 shows an exploded view of the side support,

FIG. 4 shows a sectional view of the support and spring part in a 3D projectional view.

In all figures a small vignette in the lower left corner is inserted to show the axial orientation of the 3D projectional views, and this vignette is not part of the invention.

The figures are schematic and simplified for clarity, and they just show details which are essential to the understanding of the invention, while other details are left out. Throughout, the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DESCRIPTION OF A PREFERRED EMBODIMENT

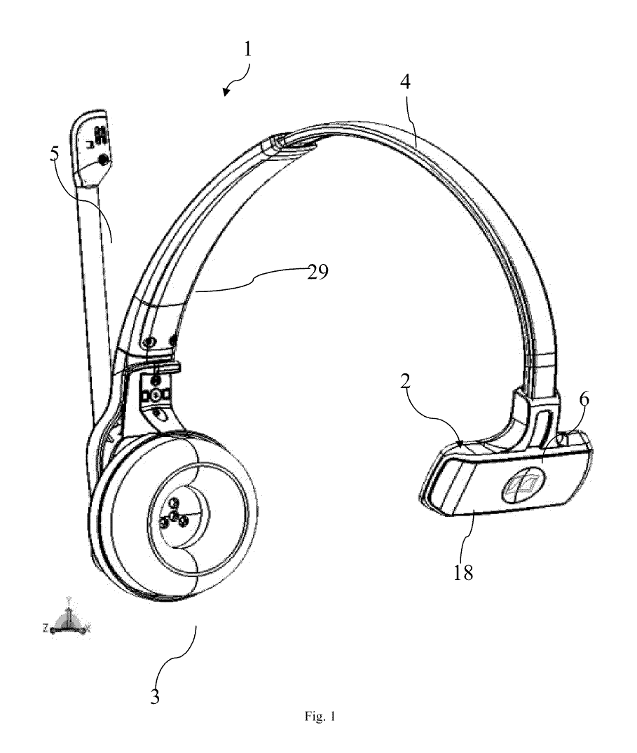

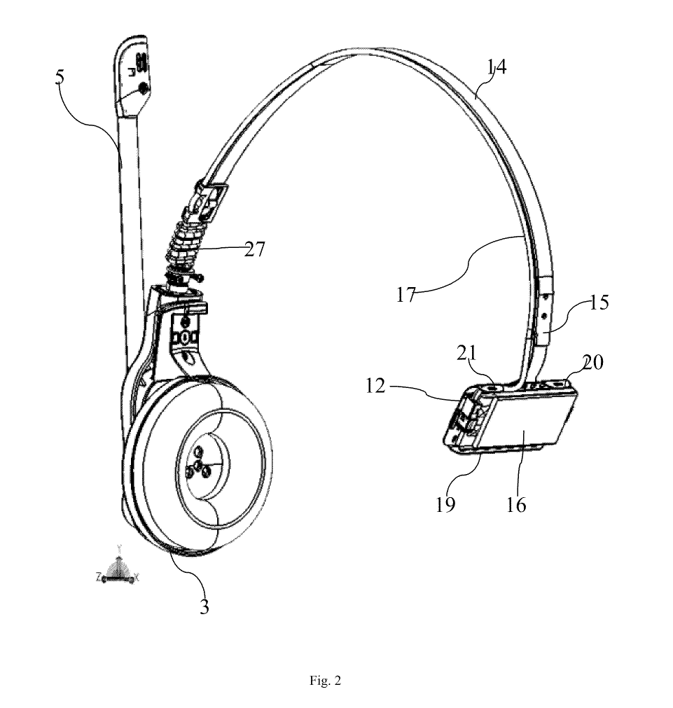

An embodiment of the invention is shown in FIG. 1. The headset 1 has a side support 2, and a speaker module 3 is coupled to the side support 2 by means of an elongate resilient spring 4 such that the speaker module 3 and the side support 2 are placeable at each their side of a users head. Hereby the spring 4 provides a holding force which presses the speaker module 3 and the side support 2 in a direction towards each other. This holding force will hold the speaker module 3 toward the ear of a user. The spring 4 has a metal core 14 (seen in FIG. 2) and comprises a re-enforcement 12 (visible in FIG. 2) at the side support 2, which extends transversely to the length direction of the elongate spring 4. The transversely extending re-enforcement 12 is arranged to ensure that the spring 4 and the side support 2 do not come apart during the users handling of the headset 1. Also the re-enforcement ensure that the pressure from the spring 4 towards a users head is dispersed over a larger area, whereby a stronger holding force is achievable without causing a painful pointed force onto the head of a user.

As further seen in FIG. 1 a microphone boom arm 5 is provided at the speaker module 3 and this boom arm is pivotally arranged, such that it may be pivoted towards the users mouth when the headset 1 is in use, and parked in the vertical position shown in FIG. 1 to extend alongside the lower part of the spring 4.

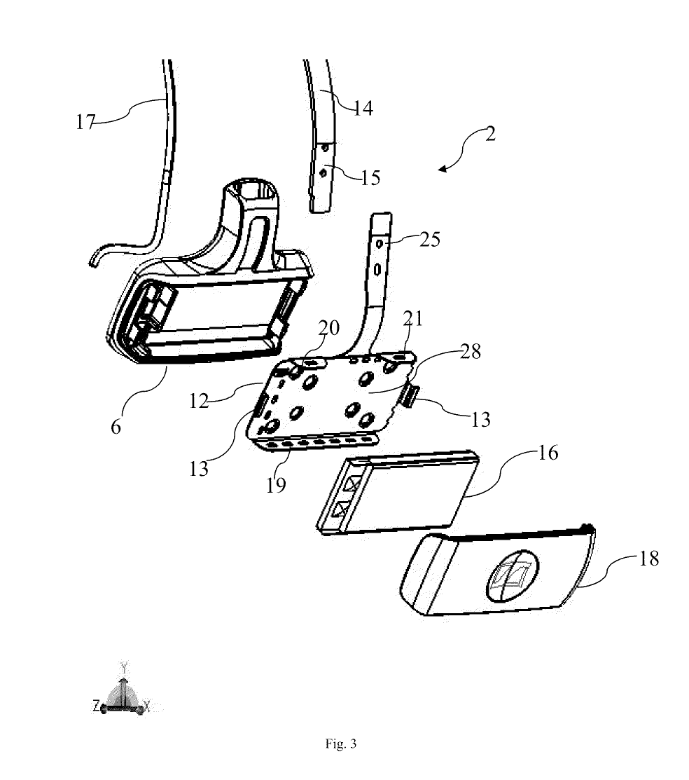

As seen in FIG. 2 the spring 4 has a metal core 14, and this core 14 is connected in a non-releasable manner to the metal re-enforcement 12 which is also shown in FIG. 2. In FIG. 2 an embedding material provided around the metal re-enforcement is not shown, however this embedding material 6 forms part of the exterior of the support 2 as seen in FIGS. 1 and 3. The core 14 and the re-enforcement are interconnected at a junction 15, 25 and this is made in the presented embodiment as a spot welded junction. Other junctions may be made such as a screw and nut junction or a glued junction or other well known type of junction which secures two metal elements in a way such, that they do not readily come apart. Possibly the spring core 14 and the re-enforcement 12 are produced from one and the same metal part and thus no actual junction between two parts is provided, but the two elements are part of the same workpiece.

In FIG. 3 an exploded view of the main elements of the side support part 2 are shown, and here a battery 16 is shown, which will be accommodated at the side support 2. Also the re-enforcement part 12 is shown and the connection leads 17 between the battery 16 and the speaker module are shown. Further, a lid 18 is disclosed, which will attach to outwardly extending flange parts 13 of the re-enforcement element 12. The lid 18 is also seen in FIG. 1.

As seen in FIG. 3 the re-enforcement 12 comprise a plate element 28 having raised rim parts 19, 20, 21 and as is visible in FIG. 2 the battery 16 is accommodated between the to raised rim parts 19, 20, 21. The plate element 28 is generally rectangular and in a conventional injection moulding production step, the embedding material part 6 will be moulded onto and around the re-enforcement 12, such that the flange parts 13 and the junction 25 will remain on-covered. The connection between the metal core 14 of the spring 4 and the junction 25 extending from the plate 18 can be made after the re-enforcement 12 have been embedded in the material 6 or possible the assemble assembled re-enforcement and spring 14 are introduced in unison into and injection moulding machine to have the material 6 moulded onto the re-enforcement. The embedded raised rim parts 19, 20, 21 will provide side support for the battery 16, when the battery is placed along the plate 28 at the re-enforcement between opposed sets of raised rim parts.

The polymer material 6 and the re-enforcement plate 12 in unison with the battery lid 18 define a battery enclosure. Preferably a rechargeable battery 16 is used, but other kinds of batteries could be used.

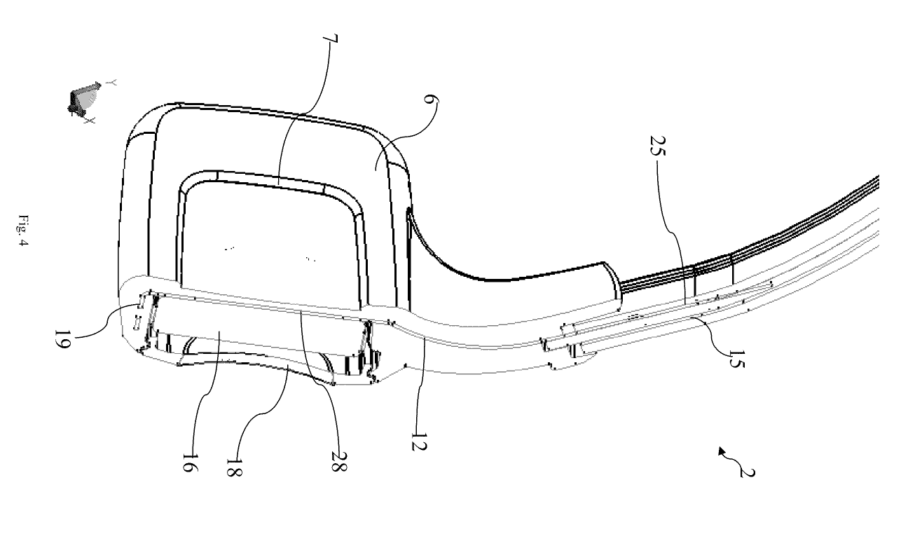

In FIG. 4 a sectional view in 3D projection is shown. The re-enforcement part 12 is seen here and the embedding material 6 moulded around it. The raised rim part 19 is visible and this part is also embedded in the material 6. The exterior of the material 6 has at the side turned towards the head a recess 7. The recess facilitates dispersed pressure on the side of the somewhat rounded side of the head of a user. From this figure the spring part 4 can also be seen as comprising a core 14 and a plastic or polymer part surrounding the core 14 and forming the exterior of the spring. The exterior polymer part of the spring is either moulded directly onto the core 14 in a process embedding the core and the lead 17, or it is produced in advance such as by extrusion and an assembly of core and surrounding material is made at a separate assembly step.

In FIG. 2 the lead 17 is shown in its entire length toward the speaker 3, and a coiled part 27 is visible next to the speaker 3. The coiled part 27 and the upper part of the spring are arranged inside a hollow sheath 29. When the spring 4 is pulled out of the sheath 29, the coil or spiralled part of the lead 17 will be extended by the windings of the coil being pulled slightly apart and while reducing the diameter of the coil in a well known manner.

1. Headset with side support, where a speaker module is coupled to a side support by means of an elongate resilient spring such that the speaker module and the side support are placeable at each their side of a users head and where the spring provides a holding force which presses the speaker module and the side support in a direction towards each other, wherein the spring comprises a metal core and where this core at the side support comprises a re-enforcement which extends transversely to the length direction of the elongate spring.

2. Headset with side support as claimed in claim 1, wherein the re-enforcement is made from metal and is at least partially embedded in a polymer material.

3. Headset with side support as claimed in claim 1, wherein a battery is accommodated at the side support and connection leads between the battery and the speaker module are provided along the resilient spring.

4. Headset as claimed in claim 4, wherein the re-enforcement comprise a plate element having raised rim parts, whereby the battery is accommodated between the raised rim parts.

5. Headset as claimed in claim 5, wherein the polymer material and the re-enforcement plate in unison with a battery lid defines a battery enclosure.

6. Headset as claimed in claim 5, wherein the battery lid attaches directly to flanged parts of the re-enforcement at each their side of the battery enclosure.

7. Headset as claimed in claim 3, wherein the lead comprise a coiled part.

8. Headset as claimed in claim 7, wherein the coiled part is arranged at the speaker module inside a sheath connected to the speaker module.

9. Headset as claimed in claim 8, wherein the resilient spring is slidably arranged in the sheath part whereby the coiled part of the lead is arranged to allow movement between the sheath and the resilient spring.
